(19) United States
(12) Patent Application Publication
(10) Pub. No.: US 2013/0079908 A1
(43) Pub. Date: Mar. 28, 2013

(54) ELECTRONIC DEVICE WITH AUTOMATIC PAUSE FUNCTION AND METHOD THEREOF

(71) Applicant: CHING-CHUNG WU, Tu-Cheng (TW)

(72) Inventor: CHING-CHUNG WU, Tu-Cheng (TW)

(73) Assignee: HON HAI PRECISION INDUSTRY CO., LTD., Tu-Cheng (TW)

(21) Appl. No.: 13/283,598

(22) Filed: Oct. 28, 2011

(30) Foreign Application Priority Data
Sep. 28, 2011 (TW) 100135070

(51) Int. Cl. G06F 17/00

(52) U.S. Cl. 700/94

(57) ABSTRACT

An electronic device includes a processing unit, and a multimedia playing unit. The processing unit directs the multimedia playing unit to play a stored multimedia file, analyzes picked up sounds to determine whether the picked up sounds include other sounds except for sounds generated by playing the multimedia file, obtains the other sounds if the picked up sounds include the other sounds, compares the other sounds with sounds in each stored sound recognition file, and directs the multimedia playing unit to pause playing the multimedia file if there is a match. A related method is also provided.

### BACKGROUND

1. Technical Field

The present disclosure relates to electronic devices and, particularly, to an electronic device capable of automatically pausing playing multimedia files and a method thereof.

2. Description of Related Art

When people use their electronic devices to listen to music or watch movies, they may have the volume so high that they don't hear the ringtones of their mobile phones when there is an incoming call or a message. Thus, people may miss an important communication.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with an automatic pause function, in accordance with an exemplary embodiment.

FIG. 2 is a flowchart of a method for automatically pausing playing multimedia files, in accordance with an exemplary embodiment.

### DETAILED DESCRIPTION

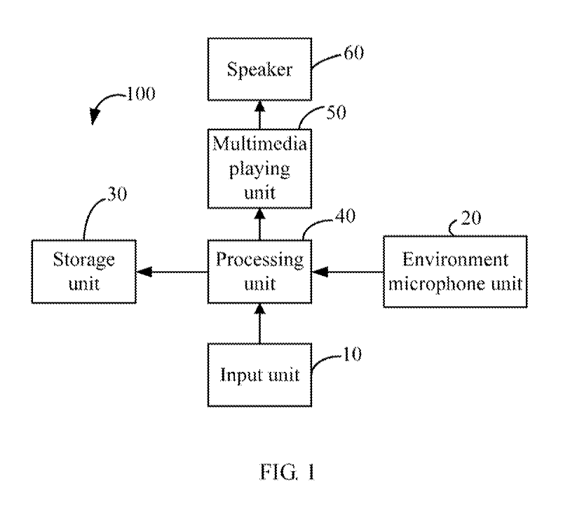

Referring to FIG. 1, an embodiment of an electronic device 100 with an automatic pause function is illustrated. The device 100 includes an input unit 10, an environment microphone unit 20, a storage unit 30, a processing unit 40, a multimedia playing unit 50, and a speaker 60. The device 100 may be a portable computer, a tablet computer, or a mobile phone. The environment microphone unit 20 picks up ambient sounds in the vicinity of the device 100. The environment microphone unit 20 may include one or more microphones. The storage unit 30 stores one or more multimedia files. The multimedia files may include audio files and/or video files. The storage unit 30 further stores one or more sound recognition files. In this embodiment, the sound recognition files are recording of sounds such as ringtones that a user wishes the device 100 to recognize. The processing unit 40 controls the multimedia playing unit 50 to play stored multimedia files. The sounds generated by playing one stored multimedia file are output through the speaker 60.

In this embodiment, when the processing unit 40 directs the multimedia playing unit 50 to play one multimedia file, the processing unit 40 analyzes picked up sounds to determine whether the picked up sounds include other sounds except for the sounds generated by playing the one multimedia file. If yes, the processing unit 40 obtains the other sounds. The processing unit 40 can obtain the other sounds using known noise cancellation technology. The processing unit 40 further compares the other sounds with sounds in the one or more sound recognition files. If the processing unit 40 determines that the other sounds match sounds of one sound recognition file, the processing unit 40 directs the multimedia playing unit 50 to pause playing the one multimedia file.

For better understanding the present disclosure, an example is given to illustrated the present disclosure. In this embodiment, the device 100 is a tablet computer, and another device is a mobile phone. A user records the ringtones of his/her mobile phone onto the tablet computer 100, saving the resulting audio files to the sound recognition files. When the tablet computer 100 is being used to play an audio file or a video file, if the mobile phone receives an incoming call or an incoming message, the ringtone is heard by the environment microphone unit 20 and compared with the stored ringtones in the sound recognition files. If there is a match, the processing unit 40 determines that the mobile phone is receiving an incoming call or an incoming message, and directs the multimedia playing unit 50 to pause playing the audio file or video file. Thus, the user can easily hear the ringtone and timely answer the incoming call or view an incoming message.

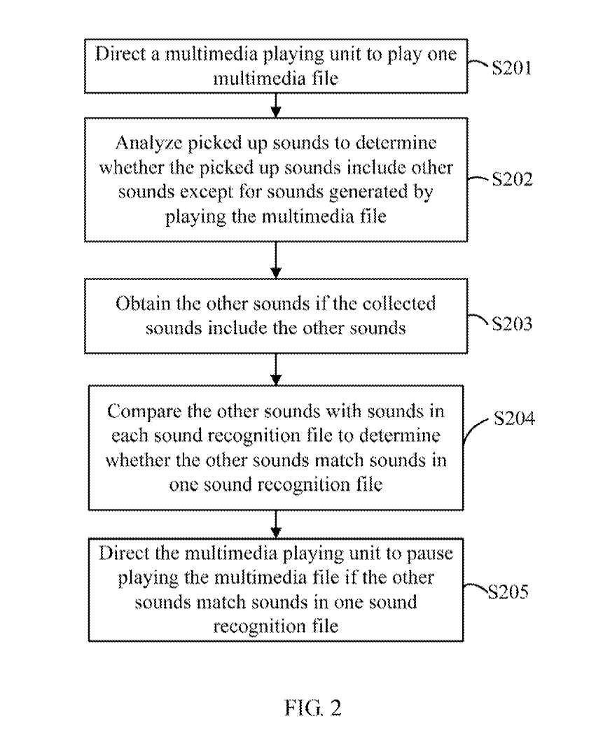

FIG. 2 is a flowchart of a method for automatically pausing playing multimedia files, in accordance with an exemplary embodiment.

In step S201, the processing unit 40 directs the multimedia playing unit 50 to play one multimedia file in response to user's operation on the input unit 10.

In step S202, the processing unit 40 analyzes picked up sounds to determine whether the picked up sounds include other sounds except for the sounds generated by playing the one multimedia file.

In step S203, the processing unit 40 obtains the other sounds if the picked up sounds include the other sounds.

In step S204, the processing unit 40 compares the other sounds with sounds of the one or more sound recognition files to determine whether the other sounds match sounds in one sound recognition file.

In step S205, the processing unit 40 directs the multimedia playing unit 50 to pause playing the one multimedia file if the other sounds match sounds in one sound recognition file.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a storage unit storing at least one multimedia file and at least one sound recognition file;
a multimedia playing unit;
an environment microphone unit to pick up ambient sounds; and
a processing unit to direct the multimedia playing unit to play one of the at least one multimedia file, analyze picked up sounds to determine whether the picked up sounds comprise other sounds except for sounds generated by playing the multimedia file, obtain the other sounds if the picked up sounds comprise the other sounds, compare the other sounds with sounds in the at least one sound recognition files, and direct the multimedia playing unit to pause playing the multimedia file if the other sounds matches sounds in one of the at least one sound recognition file.

2. The electronic device as described in claim 1, wherein the environment microphone unit comprises at least one microphone.

3. The electronic device as described in claim 1, wherein the electronic device is a laptop computer, a tablet computer, or a mobile phone.

4. The electronic device as described in claim 1, wherein each of the at least one sound recognition file comprises recording of a ringtone.

5. A method for automatically pausing playing multimedia files applied in an electronic device, the electronic device comprising an environment microphone unit to pick up ambient sounds, a storage unit storing at least one multimedia file and at least one sound recognition file, and a multimedia playing unit, the method comprising:
directing the multimedia playing unit to play one of the at least one multimedia file;
analyzing picked up sounds to determine whether the picked up sounds comprise other sounds except for sounds generated by playing the multimedia file;
obtaining the other sounds if the picked up sounds comprise the other sounds;
comparing the other sounds with sounds in the at least one sound recognition file; and
directing the multimedia playing unit to pause playing the multimedia file if the other sounds match sounds in one of the at least one sound recognition file.
